(19) United States
(12) Patent Application Publication
(10) Pub. No.: US 2018/0251243 A1
(43) Pub. Date: Sep. 6, 2018

(54) CASE READY FORM-FILL-SEAL TRAY WITH SHRINKABLE LIDDING

(71) Applicant: Terry Wright, Golden Valley, MN (US)

(72) Inventor: Terry Wright, Golden Valley, MN (US)

(21) Appl. No.: 15/863,356

(22) Filed: Jan. 5, 2018

Related U.S. Application Data
(60) Provisional application No. 62/442,671, filed on Jan. 5, 2017.

(51) Int. Cl. B65B 5/02; B65B 41/12; B65B 61/00; B65B 7/16; B65D 77/20; B65D 1/34

(52) U.S. Cl. CPC B65B 5/02; B65B 41/12; B65B 61/005; A23L 13/00; B65D 77/2024; B65D 1/34; B65B 7/167

(57) ABSTRACT

A food package and related methods of food package formation with a form-fill-seal machine utilizing both a non-forming shrinkable lidding film and a thermoforming film. The thermoforming film, in either rigid or semi-rigid forms, can be formed into a base having a pocket or cavity for storing food items. The non-forming shrinkable lidding film can be attached to a perimeter and/or flange of the base for sealing and enclosing the food items. The food package provides an economical packaging solution that avoids compromising appearance and/or packaging performance.

### RELATED APPLICATION

The present application claims the benefit of U.S. Provisional Application No. 62/442,671 entitled “DISPOSABLE TRAY”, filed Jan. 5, 2017, which is incorporated herein by reference in its entirety.

### TECHNICAL FIELD

The present invention relates to a disposable case ready food tray that is for carrying and shipping various food items, such as meat, poultry and produce. More specifically, the present invention is a case-ready form-fill-seal tray with shrinkable lidding film and related methods of assembly.

### BACKGROUND OF THE INVENTION

Food packaging plays a significant role in keeping the U.S. food supply among the safest in the world. Food packaging maintains the benefits of food processing and enables foods to travel safely for long distances from their point of origin without suffering deterioration of the product. However, packaging technology must balance food protection and convenience with other issues such as material costs and heightened social and environmental consciousness of disposable packaging materials and packaging contribution to municipal solid waste.

It has been common practice in packaging goods, including food items, to use trays formed from expanded polystyrene, such as those marketed as Styrofoam® by the Dow Chemical Company. Representative examples of trays formed from polystyrene are disclosed in U.S. Pat. Nos. 4,899,925 and 5,050,791 the disclosures of which are herein incorporated by reference in their entirety. Food trays formed from polystyrene, such as, for example, tray 58 seen in FIG. 5, have provided an inexpensive and efficient solution for food packaging and although these have been used for years with acceptable results, there are various drawbacks to using food trays made from polystyrene. Consumers and local governments have expressed significant concerns regarding the environmental impact of Styrofoam (expanded polystyrene), and meat manufacturers have struggled to transition away from the Styrofoam tray with overwrap due to cost constraints.

Fresh meat and poultry packaging have slowly transitioned away from polystyrene towards the use of thermoformed trays with a lidding film. Thermoformed trays, such as, for example, tray 50 seen in FIG. 1, can be pre-made and are typically referred to as pre-made case-ready thermoformed trays. Alternatively, tray 50 can be formed on a thermoforming machine during product packaging, and are typically referred to as a case-ready form-fill-seal tray. Both pre-made thermoformed trays and form-fill-seal trays provide a cavity in which food or other products may be placed. The top film, commonly referred to as lidding film, used in combination with the pre-made trays, is most often selected from a shrinkable lidding film, non-shrinkable lidding film, or skin packaging film varietal. The top film used in combination with form-fill-seal trays, referred to as non-forming film, has historically been a non-shrinkable lidding film, or skin packaging film varietal.

Historically, shrinkable lidding film has only been utilized as a lidding film in combination with pre-made thermoformed trays on a tray-sealing machine, such as finished package 52 in FIG. 2. This combination of materials and machine creates a package that is commonly referred to as “case-ready tray with shrinkable lidding film.” Examples of case-ready trays sealed with shrinkable lidding film are disclosed in U.S. Patent Application Publ. No. 2008-0152772 to Berning, U.S. Pat. No. 5,744,181 to Sornay, and EP Application Publ. No. 3,023,339 to Izquierdo, the disclosures of which are herein incorporated by reference in their entirety.

The result of using a shrinkable lidding film with a pre-made thermoformed tray is a clear, smooth and taut top film that consumers prefer. However, a crucial deficiency of this particular combination is cost. Use of shrinkable lidding film as a top film, in combination with a pre-made case-ready thermoformed tray results in an overall product that is cost prohibitive when compared with the standard Styrofoam tray and over-wrap packages.

A more cost effective, yet still cost prohibitive alternative is the use of non-shrinkable lidding film as a top film in combination with a pre-made thermoformed tray, such as tray 54 as seen in FIG. 3. While this combination provides a less expensive alternative, it has inherent and incurable deficiencies. The use of non-shrinkable lidding film as a top film with a pre-made case-ready tray presents a cosmetic defect of wrinkling, which becomes increasingly pronounced over the life cycle of the packaged fresh meat or poultry product. The affect of wrinkling as seen on tray 54 of FIG. 3 and tray 56 of FIG. 4, is a commercial shortcoming that has forced companies to spend significantly more to package their fresh meat and poultry products utilizing the combination of pre-made thermoformed trays and shrinkable-lidding film.

Manufacturers to date continually choose from increasing costs by utilizing pre-made trays with shrinkable lidding or potentially alienating their consumer by remaining in the Styrofoam tray with overwrap. Accordingly, there is a need for an inexpensive and environmentally conscious thermoformed tray with a lidding film that is attractive and cost efficient.

### SUMMARY OF THE INVENTION

Representative embodiments of the present invention are directed to a case-ready form-fill-seal tray with shrinkable lidding as well as related methods for creating the tray that involve utilizing a shrinkable lidding film in combination with semi-rigid or rigid forming film on a form-fill-seal machine. The method can be practiced with conventional form-fill-seal equipment to form trays for use in packaging a variety of goods including food items. This equipment can be aligned in either a horizontal or vertical direction, with the flow path of rollstock film and a product to be packaged moving in essentially the same direction, either horizontally or in a downward vertical direction such as, for example, as disclosed in U.S. Pat. No. 4,719,741 to Mabry, which is hereby incorporated by reference in its entirety.

In an embodiment, a package comprises a semi-rigid or rigid forming film for creating a thermoformed tray and a non-forming shrinkable lidding film sealed to the tray. The semi-rigid or rigid thermoformed tray having a first surface, the surface defining a cavity formed therein for receiving a food product, and a flange disposed around the periphery of the tray; a product disposed in the pocket; and a shrinkable lidding film disposed over the product, and sealed to the thermoformed tray in the region of the flange of the thermoformed tray. The shrinkable lidding film preferably does not extend beyond the flange of the thermoformed tray. In the most preferred embodiment the shrinkable lidding film sealed to a semi-rigid or rigid forming film on a form-fill-seal machine creates a finished package that looks and performs similarly to a “case-ready pre-made tray with shrinkable lidding film,” but at a significantly lower cost.

The present invention is advantageous in that the specific combination of materials and method described above creates an economical option for processors currently using a “Styrofoam tray with overwrap,” non-shrinkable lidding film with a pre-made thermoformed tray, non-shrinkable lidding with a thermoformed tray, or shrinkable lidding with a pre-made thermoformed tray. The specific combination of materials and methods of the present invention also creates an option to replace the pre-made case-ready trays with shrinkable lidding film at a significant cost reduction, while retaining the same general appearance and performance to the consumer. Ultimately, the combination of materials and machine described with the present invention allows manufacturers to fulfill the consumer want of eliminating Styrofoam trays without increasing cost/price, while providing fresh and attractive products to consumers.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a pre-made thermoformed case-ready tray according to the prior art.

FIG. 2 is a perspective view of a food package comprising a case-ready pre-made thermoformed tray with shrinkable lidding film according to the prior art.

FIG. 3 is a perspective view of a food package with non-shrinkable lidding film and a pre-made thermoformed tray according to the prior art.

FIG. 4 is a perspective view of consequential wrinkling when using non-shrinkable lidding film and a form-fill-seal thermoformed tray according to the prior art.

FIG. 5 is a prior art perspective view of a Styrofoam tray with overwrap.

FIG. 6 is a perspective view of a disposable tray with non-forming shrinkable lidding film and semi-rigid or rigid thermoforming film tray according to an embodiment of the present invention.

FIG. 7 is a perspective view of a form fill seal machine.

FIG. 8 is a perspective view of the sealing steps using a form fill seal machine.

FIG. 9 is a perspective view of rolls of forming film.

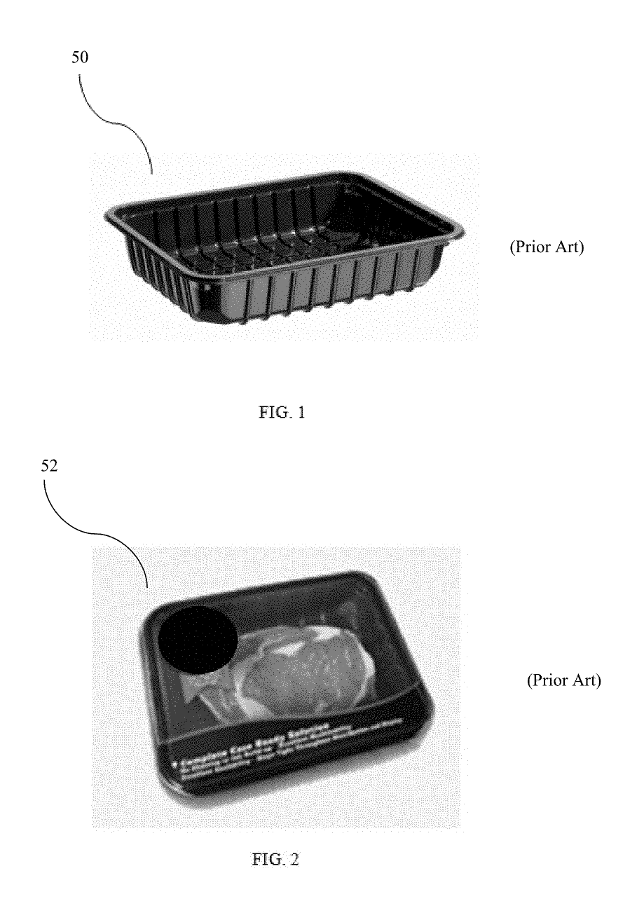

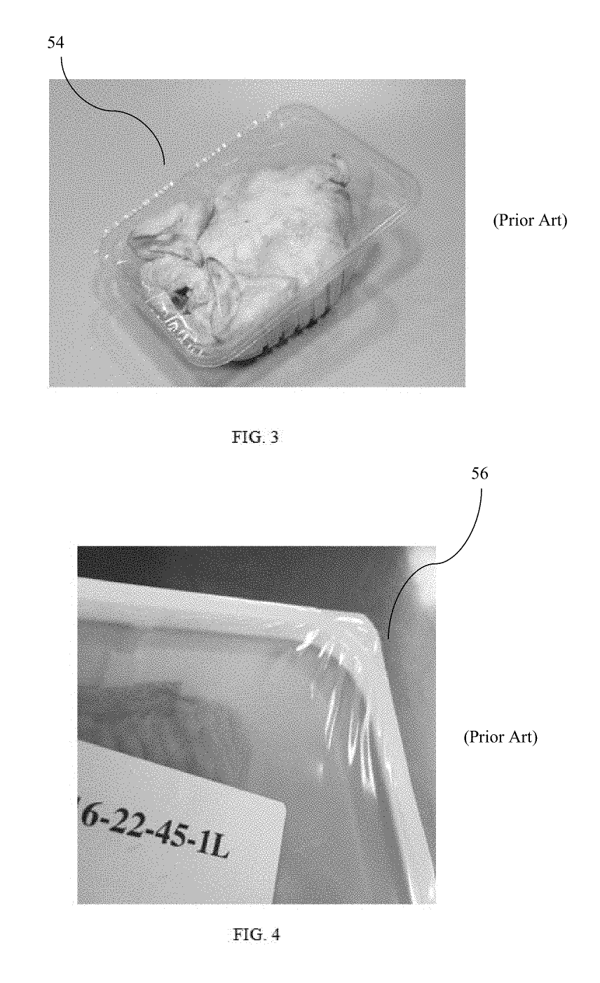

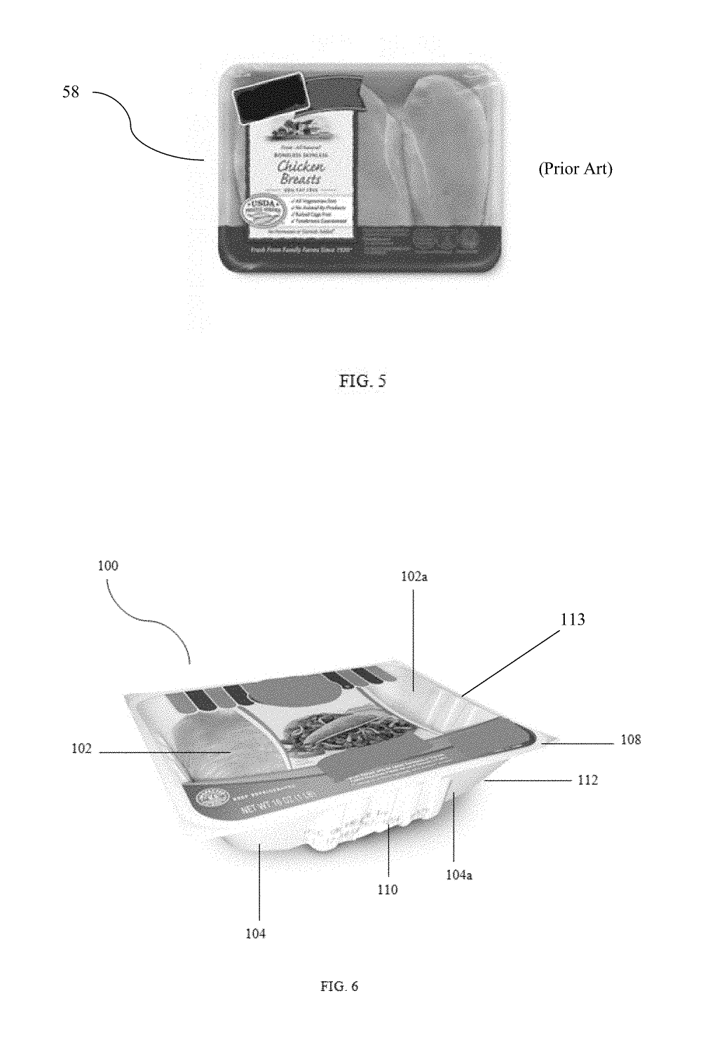

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

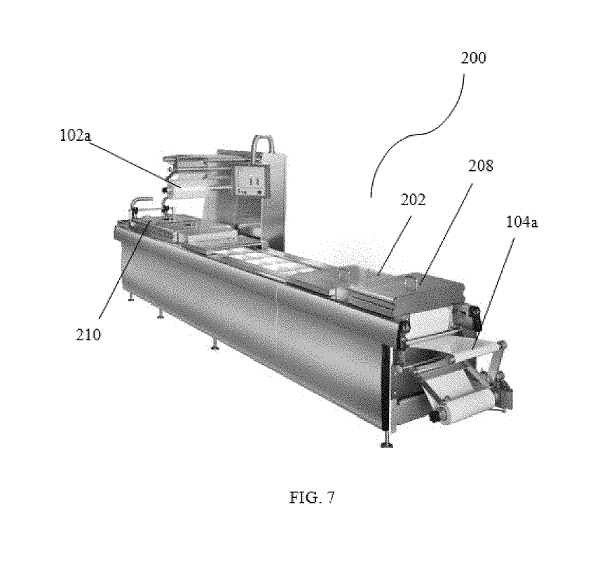

Referring to FIG. 6, a case-ready form-fill-seal disposable tray 100 of the present invention can comprise a lid 102 and a thermoformed tray 104. Lid 102 generally comprises a non-forming shrinkable lidding film 102a and the thermoformed tray 104 generally comprises a thermoforming film 104a. Non-forming shrinkable lidding film 102a can comprise a multi-layer polymeric based substrate with an oxygen barrier component that can utilized in laminated or unlaminated form. In some embodiments, the non-forming shrinkable lidding film 102a can be fabricated with additional additives providing characteristics such as, for example, anti-fog or easy peel characteristics. Thermoforming film 104a can comprise a multi-layer or mono-layer polymer based substrate with an oxygen barrier component that can utilized in laminated or unlaminated form. The thermoforming film 104a can contain an additive for easy peel sealing characteristics. In the embodiment depicted in FIG. 6, the thermoforming film 104a comprises a semi-rigid thermoforming film. Alternatively, the thermoforming film 104a can comprises a rigid thermoforming film. As illustrated in FIG. 9, thermoforming film 104a can be supplied in continuous rolls such as, for example, a roll of semi-rigid thermoforming film 116 or a roll of rigid thermoforming film 118 for use with conventional form-fill-seal equipment. Non-forming shrinkable lidding film 102a and thermoforming film 104a, in either a rigid or semi-rigid form, is commercially available from suppliers including under the Cryovac® brand offered by Sealed Air Corporation of Charlotte, N.C.

The thermoformed tray 104 can define a base 110, wherein the base 110 is substantially rectangular in shape and has a plurality of side walls 112 that extend upwardly and slightly outwardly from said base 110, wherein said side walls 112 define a pocket 206 having a perimeter edge 113. In one embodiment of the tray 104, the sidewalls 112 comprise a flange 108 that is integrally joined to the upper edges of the sidewalls 112 and extends outwardly around the upper perimeter edge 113 as defined by the sidewalls 112. In some embodiments of the present invention, the shape of tray 104 and/or pocket 206 is square. In other embodiments the shape of the tray 104 and/or pocket 206 can be round or rectangular. In yet other embodiments, the shape of the tray 104 and/or pocket 206 can be any shape able to contain a product and can be uniquely tailored to fit product of varying sizes and shapes.

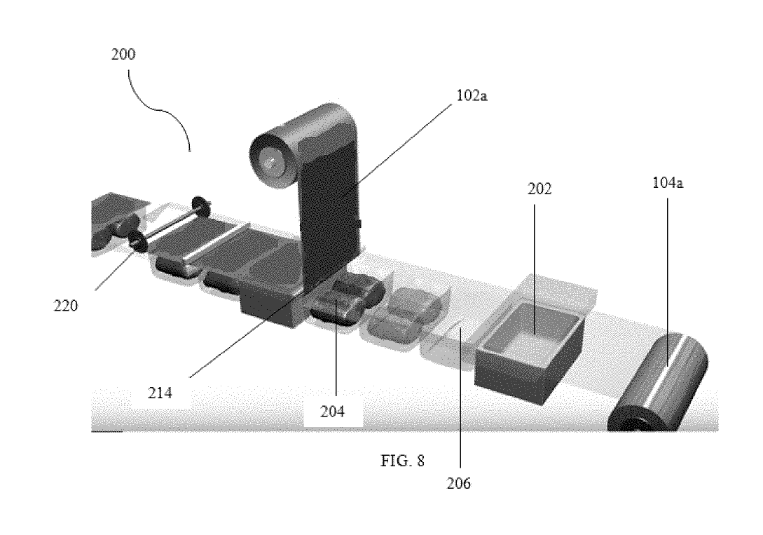

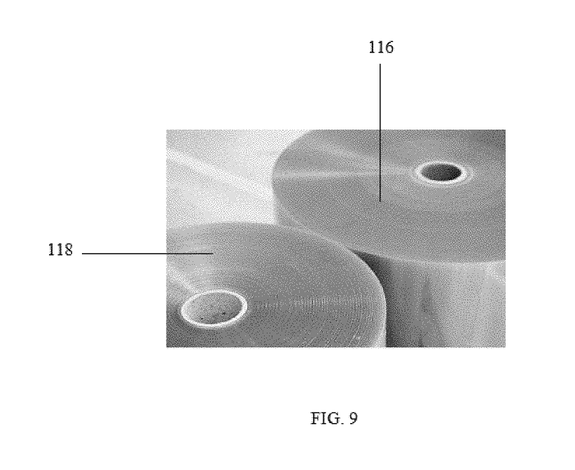

Referring now to FIGS. 7 and 8, a form-fill-seal machine 200 is used to create the disposable tray 100 in accordance with an embodiment of the present invention. A disposable tray 100 in accordance with one embodiment is assembled by feeding a thermoforming film 104a toward a forming station 202 of the form-fill-seal machine 200, thermoforming a pocket 206 in thermoforming film 104a such that a flange 108 extends from the perimeter edge 113 of pocket 206. In FIGS. 7 and 8 a product 204 is placed into the pocket and lidding film 102a is sealed to the thermoforming film 104a about said pocket 206 and to a portion of the flange 108 to form a filled tray, and at least some the films 102a and 104a extending beyond the perimeter edge 113 is cut away. According to one embodiment of the invention this product is a fresh meat product.

In the embodiment of FIGS. 7 and 8, the feed rate of thermoforming film 104a is substantially equal to the feed rate of lidding film 102a and feeds in a direction parallel to the longitudinal axis of form-fill-seal machine 200, the lidding film 102a being a non-forming shrinkable lidding film. In this same embodiment, the thermoforming film 104a is fed with a tension substantially equal to or less than the tension with which the lidding film 102a is fed. In yet the same embodiment of the method, the thermoforming film 104a and the lidding film 102a can be sealed to one another at the perimeter edge 113 of the pocket 206 or on the flange 108, outside the perimeter edge 113 defined by the sidewalls 112, at sealing station 214.

In operation a user positions a role of thermoforming film 104a on form-fill-seal machine 200. In some embodiments, thermoforming film 104a is a semi-rigid forming film 116. In other embodiments, thermoforming film 104a is a rigid forming film 118. The method comprises a tray forming step in which the film is arranged on form-fill-seal machine 200 at a tray thermoforming end 208. The method can comprise the additional step of positioning shrinkable lidding film 102a on form-fill-seal machine 200 at sealing station 214.

In operation the feed rate of thermoforming film 104a is substantially equal to the feed rate of lidding film 102a. Thermoforming film 104a can be fed with a tension substantially equal to or less than a tension with which lidding film 102a is fed. Thermoforming film 104a enters forming station 202 and pocket 206 is thermoformed into thermoforming film 104a. Pocket 206 and lidding film 102a are fed toward sealing station 214 in a feeding direction. The feeding direction of the method is along the longitudinal axis of machine 200 and in a direction away from thermoforming end 208. In the method, pocket 206 and lidding film 102a are sealed to one another at perimeter edge 113 or otherwise along flange 108 at sealing station 214 after the optional insertion of a product and at least some of the films 102a and 104a are cut away at a cutting station 220.

With the case-ready thermoformed disposable tray and method of the present invention, environmental impact from Styrofoam trays will be reduced and costs associated with pre-made thermoformed trays can be mitigated. The combination of a shrinkable lidding film and a semi-rigid or rigid forming film according to embodiments of the invention overcomes environmental impact, cost, and wrinkling that is inherent to all other combinations of packaging previously discussed.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of making a case-ready form-fill-seal tray with shrinkable lidding comprising the steps of:
feeding a thermoform film toward a forming station on a form-fill-seal machine;
thermoforming a pocket in said thermoforming film wherein a flange extends from a perimeter edge of the pocket;
feeding a non-forming film over the pocket
sealing the non-forming film over the pocket to form a filled tray; and
cutting away at least some of the film extending beyond the perimeter edge of the flange.

2. The method according to claim 1, wherein a thermoforming feed rate of the thermoforming film is substantially equal to a non-forming feed rate of the non-forming film.

3. The method according to claim 2, wherein the thermoforming film is fed with a thermoforming tension substantially equal to or less than a non-forming tension with which the non-forming film is fed.

4. The method according to claim 3, wherein the step of sealing the non-forming film causes the non-forming film and the thermoforming film to be sealed to one another in an area of attachment beyond the perimeter edge defined by the pocket.

5. The method according to claim 3, wherein the thermoforming film and non-forming film are fed toward a sealing station in a feeding direction parallel to a longitudinal axis of the form-fill-seal machine.

6. The method according to claim 1, wherein the non-forming film is a shrinkable-lidding film.

7. The method according to claim 1, wherein the thermoforming film is a semi-rigid forming film.

8. The method according to claim 1, wherein the thermoforming film is a rigid forming film.

9. The method according to claim 1, wherein a product is placed into the pocket prior to sealing the non-forming film over the pocket.

10. The method according to claim 9, wherein the product is a food product.

11. The method according to claim 9, wherein the food product is a fresh meat product.

12. A case-ready form-fill-seal tray formed according to the method of claim 1.

13. A case-ready form-fill-seal tray with shrinkable lidding comprising:
a solid thermoformed tray comprising:
a base,
a plurality of sidewalls extending upwardly and slightly outwardly from the base; and
a flange integrally joined to the upper edges of the sidewalls and extending outwardly around an upper periphery of the sidewalls;
wherein the base and the plurality of sidewall define a pocket configured to hold a product therein, and wherein a non-forming film is sealed to the tray and over the pocket to enclose said product.

14. The tray of claim 13, wherein the non-forming film is sealed to the flange.

15. The tray of claim 13, wherein the non-forming film is a shrinkable lidding film.

16. The tray of claim 13, wherein the base is substantially rectangular in shape.

17. The tray of claim 13, wherein the base is substantially round in shape.

18. The tray of claim 13, where the base is configured with a size and shape configured to hold the product.

19. The tray of claim 13, wherein said product is a fresh meat product.
